(19) United States
(12) Patent Application Publication
(10) Pub. No.: US 2007/0172111 A1
(43) Pub. Date: Jul. 26, 2007

(54) INSPECTION APPARATUS OF OBJECT TO BE INSPECTED

(76) Inventor: Hiroyuki IKEDA, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/533,152

(22) Filed: Sep. 19, 2006

(30) Foreign Application Priority Data
Jan. 20, 2006 (JP) 2006-012911

(51) Int. Cl. G06K 9/00

(52) U.S. Cl. 382/149

(57) ABSTRACT

It is to inspect an object to be inspected according to inspection image data of the object and previously obtained reference data, take in specified image data corresponding to at least one specified area on the object in parallel with the inspection of the object, and store the above data into the first memory.

### CROSS-REFERENCE TO RELATED APPLICATIONS

This application is based upon and claims the benefit of priority from prior Japanese Patent Application No. 2006-012911, filed Jan. 20, 2006, the entire contents of which are incorporated herein by reference.

### BACKGROUND OF THE INVENTION

1. Field of the Invention

The present invention relates to an inspection apparatus of an object to be inspected by comparing the inspection image data, which picks up the image of the object such as a photomask on which a pattern of a semiconductor integrated circuit is formed and inspects the object according to the inspection image data thus obtained and reference data.

2. Description of the Related Art

For example, assume that there is a photomask on which a pattern of a semiconductor integrated circuit is formed. This photomask is subject to a pattern defect inspection. A pattern defect inspection apparatus picks up the image of the photomask to get the inspection image data. Simultaneously, the pattern defect inspection apparatus creates reference data according to the design data of the photomask stored in a CAD apparatus and the like. The pattern defect inspection apparatus compares the inspection image data with the reference data and recognizes a disagreement between the inspection image data and the reference data as a defected portion of the pattern. The pattern defect inspection apparatus takes the defect image data corresponding to the defected portion from the inspection image data and stores it into a defect memory.

There are some areas which require a detailed inspection of pattern line width distribution and the like on the surface of a photomask. These areas are referred to as critical points and important for an inspection of a semiconductor integrated circuit. These areas need to be inspected with a severe inspection standard, specifically with the threshold for defect identification set higher. These areas are obtained from the result of an exposure simulation on a semiconductor wafer through a photomask. Alternatively, they are obtained from the result of an actual exposure on the semiconductor wafer through the photomask.

The pattern defect inspection apparatus only checks a defected portion of a pattern and stores the defect image data of this defected portion into a defect memory.

This kind of the pattern defect inspection apparatus is disclosed in, for example, Jpn. Pat. Appln. KOKAI Publication Nos. 11-87446, 2000-172843 and 2002-14062.

In Jpn. Pat. Appln. KOKAI Publication No. 11-87446, the image feature amounts of defects are computed in synchronization with the detection of the defects and the defects are classified into cluster according to the computed feature amounts. In Jpn. Pat. Appln. KOKAI Publication No. 2000-172843, the image data of the respective dies is sequentially obtained while scanning a semiconductor wafer on which a plurality of dies are formed, temporarily stored into a buffer memory for analysis, the image data of the respective dies stored into the same buffer memory for analysis is compared with each other, and when there is a difference, the defect information is generated. As soon as the defect information is generated, a defect to be analyzed is selected, the image data necessary for analyzing the defect is read from the buffer memory for analysis and transferred to automatic defect classifying means where the type of the defect is classified. This patent document discloses the simultaneous execution of the defect detection and the classification. Jpn. Pat. Appln. KOKAI Publication No. 2002-14062 discloses such a technique that in synchronization or in parallel with the pattern inspection, each defect feature amount including the signal amount of a charged particle beam image of the defected portion is calculated in order to immediately sort the defects according to the electrical properties.

### BRIEF SUMMARY OF THE INVENTION

According to a first aspect of the present invention, there is provided an image taking method comprising: inspecting an object to be inspected, according to inspection image data obtained by imaging the object and reference data previously obtained; and taking specified image data corresponding to at least one specified area on the object, in parallel with the inspection of the object.

According to a second aspect of the present invention, there is provided an inspection method for an object to be inspected, comprising: picking up an image of the object to obtain inspection image data; inspecting the object according to the inspection image data and reference data previously obtained; and taking in specified image data corresponding to at least one specified area on the object and storing it into a memory, in parallel with the inspection of the object.

According to a third aspect of the present invention, there is provided an inspection apparatus of an object to be inspected, comprising: an image pickup section which picks up an image of the object; an inspection section which inspects the object according to inspection image data obtained by the image pickup section and reference data previously obtained; a first memory; and an image take-in section which takes in specified image data corresponding to at least one specified area on the object and stores the same data into the first memory, in parallel with the inspection processing of the object by the inspection section.

### BRIEF DESCRIPTION OF THE SEVERAL VIEWS OF THE DRAWING

FIG. 1 is a structural view showing one embodiment of a pattern defect inspection apparatus according to the invention;

FIG. 2 is a view showing one example of critical points on a photomask to be inspected by the same apparatus;

FIG. 3 is a flow chart of specified area designation in the same apparatus; and

FIG. 4 is a flow chart of inspection operation in the same apparatus.

### DETAILED DESCRIPTION OF THE INVENTION

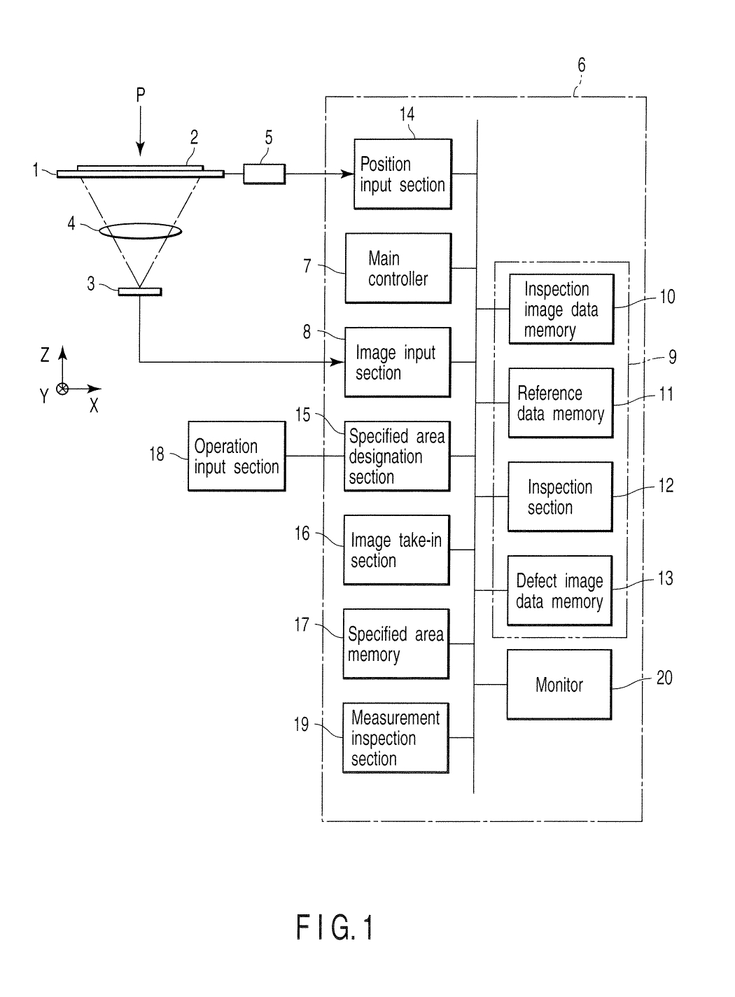

One embodiment of the invention will be described with reference to the drawings. FIG. 1 is a structural view of a pattern defect inspection apparatus. For example, a photomask 2 is mounted on an XY stage 1 as an object to be inspected. A semiconductor pattern of a semiconductor integrated circuit is formed on the photomask 2. A sensor 3 is provided in the lower portion of the XY stage 1. A magnification optical system 4 such as an objective lens is provided between the XY stage 1 and the sensor 3. The sensor 3 picks up an optical image of the semiconductor pattern on the photomask 2 through the magnification optical system 4 such as the objective lens and outputs its image signal. A laser interferometer 5 is provided in the XY stage 1. The laser interferometer 5 detects the XY position of the XY stage 1 having the photomask 2 mounted thereon and outputs its XY position data.

A defect detection unit 6 detects defect data of the photomask 2 by comparing the inspection image data of the photomask 2 obtained according to the inspection data (VSB) through the calculation of the computer with the reference data. The inspection data includes the information for inspecting the pattern of the photomask 2. In parallel with the detection of the defect data on the photomask 2, the defect detection unit 6 takes in the specified image data corresponding to at least one specified area which requires a particular inspection on the photomask 2, i.e., a critical point.

The defect detection unit 6 is shown in the function blocks of the computer in FIG. 1. A main controller 7 is formed by a CPU, for example. The main controller 7 issues an input instruction of the image signal supplied from the sensor 3 to an image input section 8. The main controller 7 also issues an operation instruction to a pattern defect inspection section 9. The image input section 8 receives the image signal outputted from the sensor 3 upon receipt of the input instruction from the main controller 7 and transmits it to the pattern defect inspection section 9 as inspection image data. The inspection image data is the optical image of the semiconductor pattern on the photomask 2.

The pattern defect inspection section 9 inspects the pattern formed on the photomask 2 by comparing the inspection image data with the reference data previously obtained. The pattern defect inspection section 9 includes an inspection image data memory 10, a reference data memory 11, an inspection section 12, and a defect image data memory 13. The pattern defect inspection section 9 stores the inspection image data transmitted from the image input section 8 into the inspection image data memory 10.

The reference data memory 11 stores the reference data of the semiconductor pattern formed on the photomask 2. Here, creation of the reference data will be described. The photomask 2 is designed using a CAD (computer aided design) apparatus. The design data is taken out from the CAD apparatus and transmitted to a data expansion circuit. The data expansion circuit expands the design data and sends it to a reference data creating circuit. The reference data creating circuit filters the design data according to the point spread function (PSF) of simulating the optical image of the semiconductor pattern on the photomask 2, hence to create reference data.

The inspection section 12 reads the inspection image data stored in the inspection image data memory 10 and at the same time, reads the reference data having the same XY coordinate as the inspection image data from the reference data memory 11. The inspection section 12 compares the read inspection image data with the reference data and recognizes a disagreement as a defected portion of the pattern. In this case, the position input section 14 enters the XY position data outputted from the laser interferometer 5 into the inspection section 12. Receiving the XY position data entered by the position input section 14, the inspection section 12 reads the reference data having the same XY coordinate as the inspection image data from the reference data memory 11 based on the XY position data.

As a result of comparison between the inspection image data and the reference data, when recognizing the pattern defected portion, the inspection section 12 takes in the defect image data corresponding to the pattern defected portion from the inspection image data and stores it into the defect image data memory 13.

In parallel with the pattern inspection on the photomask 2 by the pattern defect inspection section 9, the defect detection unit 6 takes in the specified image data corresponding to at least one specified area which requires a particular inspection on the photomask 2. The defect detection unit 6 includes a specified area designation section 15, an image take-in section 16, and a specified area memory 17.

The specified area designation section 15 is connected to an operation input section 18 including a keyboard, a mouse, and the like. The operation input section 18 receives an area which requires a detailed inspection of pattern line width distribution, in other words, a critical point on the photomask 2, for example, according to a designer's operation. These critical points are taken into the inspection data, for example, as a position designation file (specified point). The critical point is important in the inspection of the photomask 2. The critical point is an area which requires a severe inspection standard and has to be inspected with the threshold for defect identification set higher.

This area is obtained as follows. The design data of the photomask 2 stored in the CAD apparatus is passed to a simulation system. The simulation system simulates the exposure on the semiconductor wafer through the photomask 2. The area is obtained from the simulation result. Alternatively, the area is obtained from the result of the actual exposure on the semiconductor wafer through the photomask 2.

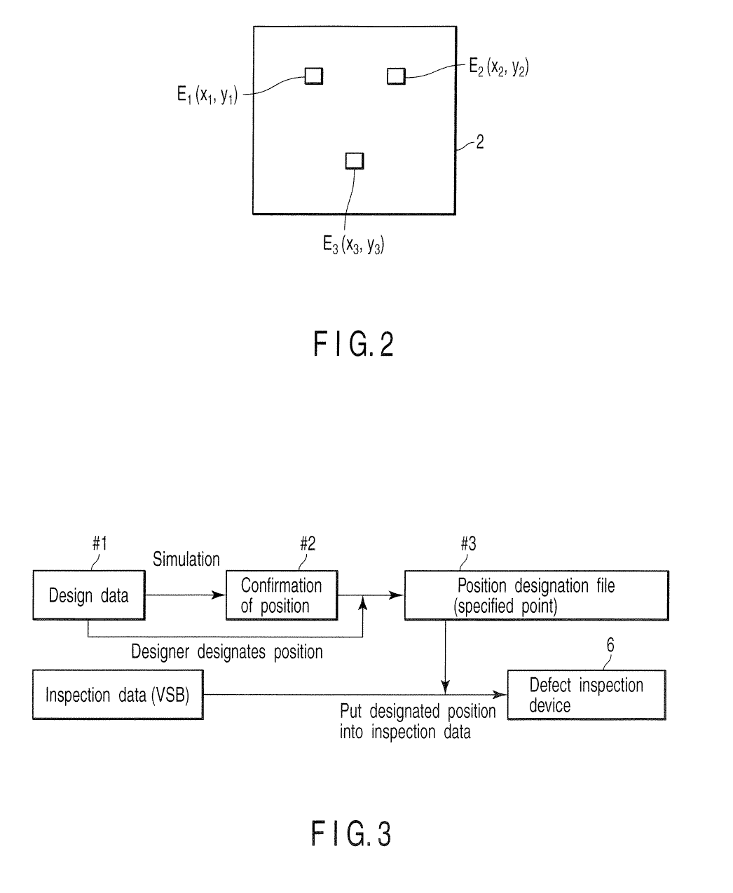

FIG. 2 shows one example of the critical points E₁ to E₃ on the photomask 2. These critical points E₁ to E₃ are respectively specified as XY coordinates E₁ (x₁, y₁), E₂ (x₂, y₂), and E₃ (x₃, y₃). The critical points E₁ to E₃ are indicated not only by the point coordinates but also they may be shown in the two dimensional areas which are previously set around the XY coordinates E₁ to E₃.

During the inspection of the photomask 2 by the pattern defect inspection section 9, the image take-in section 16 checks whether the XY coordinates on the photomask 2 under the inspection are the specified areas designated by the specified area designation section 15, specifically the XY coordinates E₁ (x₁, y₁) to E₃ (x₃, y₃) of the critical points E₁ to E₃. As a result, when the image take-in section 16 recognizes that they are the XY coordinates E₁ (x₁, y₁) to E₃ (x₃, y₃) of the specified areas, it takes in the image data of the XY coordinates E₁ (x₁, y₁) to E₃ (x₃, y₃) of the specified areas in the size specified as the specified image data and stores the data into the specified area memory 17. The image data of the XY coordinates E₁ (x₁, y₁) to E₃ (x₃, y₃) of the specified areas is extracted from the inspection image data outputted from the image input section 8.

A measurement inspection section 19 reads the respective specified image data stored in the specified area memory 17. The specified image data is the data of the specified areas on the photomask 2 which require a predetermined inspection level or a higher level, specifically, the data corresponding to the respective XY coordinates E₁ (x₁, y₁) to E₃ (x₃, y₃) of the respective critical points E₁ to E₃. The measurement inspection section 19 performs at least one processing out of distribution measurement, reinspection, and comparison inspection (hereinafter, referred to as Die-to-Die inspection). In the distribution measurement, pattern line width distribution or transmittance distribution is measured with respect to the specified image data. In the reinspection, the specified image data is rechecked. In the Die-to-Die inspection, the same patterns formed on the specified image data are compared with each other and checked. The distribution measurement, the reinspection, or the Die-to-Die inspection is selectively instructed, for example, by a designer.

The main controller 7 controls display of a monitor 20 such as a liquid crystal display. The main controller 7 displays on the monitor 20 the defect image data stored in the defect image data memory 13 and the measurement results checked by the measurement inspection section 19, including the result of the distribution measurement, the result of the reinspection, and the result of the Die-to-Die inspection.

Designation of the respective XY coordinates E₁ (x₁, y₁) to E₃ (x₃, y₃) of the respective critical points E₁ to E₃ on the photomask 2, as illustrated in FIG. 2, will be described according to the flow chart of the specified area designation shown in FIG. 3.

The design data of the photomask 2 is created, for example, by the designer's operation of the CAD apparatus. The design data is passed to the simulation apparatus from the CAD apparatus in Step #1. The simulation apparatus simulates the exposure on the semiconductor wafer through the photomask 2. According to the results of the simulation, the designer confirms the areas which require the detailed inspection such as the pattern line width distribution on the photomask 2, more specifically, the positions of the respective XY coordinates E₁ (x₁, y₁) to E₃ (x₃, y₃) of the respective critical points E₁ to E₃, as illustrated in FIG. 2, and determines these positions in Step #2.

The XY coordinates E₁ (x₁, y₁) to E₃ (x₃, y₃) of the critical points E₁ to E₃ are entered into the specified area designation section 15 according to the designer's operation of the operation input section 18. The specified area designation section 15 puts the respective XY coordinates E₁ (x₁, y₁) to E₃ (x₃, y₃) of the respective critical points E₁ to E₃ entered from the operation input section 18 into the inspection data as the position designation file (specified point) in Step #3.

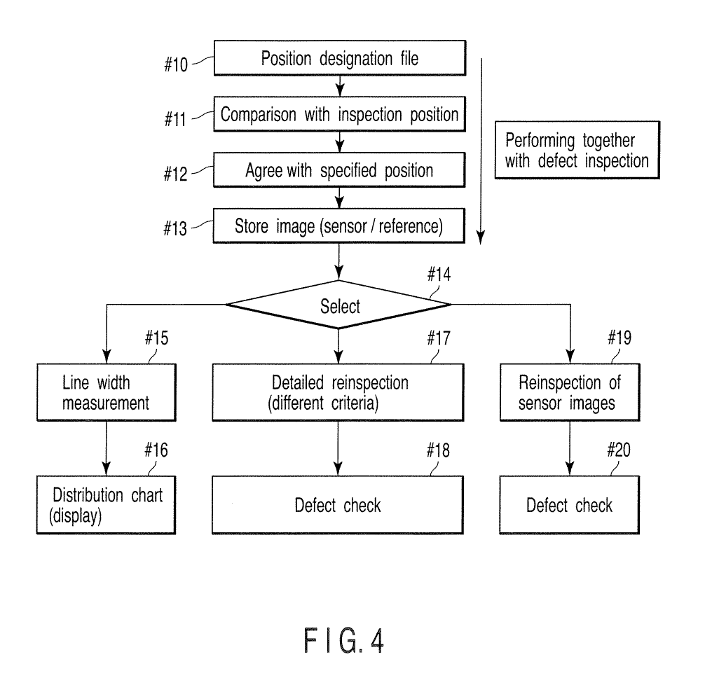

The inspection operation about the photomask 2 will be described according to the flow chart of the inspection operation shown in FIG. 4.

The design data of the CAD apparatus is taken out. The design data is sent to a data expansion circuit. The data expansion circuit expands the design data and sends it to a reference data creating circuit. The reference data creating circuit filters the design data according to the point spread function (PSF) of simulating the optical image of the semiconductor pattern on the photomask 2, hence to create reference data. The reference data is stored into the reference data memory 11.

In the meantime, an inspection beam P is irradiated on the photomask 2 on the XY stage 1. The XY stage 1 moves toward the XY direction, to scan the photomask 2 with the inspection beam P. The sensor 3 picks up the optical image of the semiconductor pattern on the photomask 2 through the magnification optical system 4 such as the objective lens and outputs its image signal. The laser interferometer 5 detects the XY position of the XY stage 1 on which the photomask 2 is placed and outputs the XY position data.

The image input section 8 sequentially receives the image signals outputted from the sensor 3 and sends them to the pattern defect inspection section 9 as the inspection image data. The pattern defect inspection section 9 stores the inspection image data sent from the image input section 8, which is the optical image of the semiconductor pattern on the photomask 2, into the inspection image data memory 10.

The inspection section 12 receives the XY position data outputted from the laser interferometer 5 through the position input section 14 and reads the reference data having the same XY coordinate as the inspection image data from the reference data memory 11, based on the XY position data. The inspection section 12 reads the inspection image data stored in the inspection image data memory 10 and at the same time, reads the reference data having the same XY coordinate as the inspection image data from the reference data memory 11. The inspection section 12 compares the inspection image data with the reference data and recognizes a disagreement as a defected portion of the pattern.

When it is judged that there is a pattern defected portion, the inspection section 12 takes in the defect image data corresponding to the pattern defected portion from the inspection image data and stores it into the defect image data memory 13.

In parallel with the defect inspection of the photomask 2, the defect detection unit 6 takes in the specified image data corresponding to the critical points on the photomask 2. Specifically, the image take-in section 16 expands the inspection data in Step #10 and obtains the respective XY coordinates E₁ (x₁, y₁) to E₃ (x₃, y₃) of the respective critical points E₁ to E₃ shown in FIG. 2 from the position designation file included in the inspection data.

The image take-in section 16 checks whether the XY coordinates under the inspection of the photomask 2 are the specified areas designated by the specified area designation section 15, specifically, the respective XY coordinates E₁ (x₁, y₁) to E₃ (x₃, y₃) of the respective critical points E₁ to E₃, while the pattern defect inspection section 9 is inspecting the photomask 2, in Step #11.

When it is judged that the XY coordinates of the photomask 2 under the inspection agree with the XY coordinates E₁ (x₁, y₁) to E₃ (x₃, y₃) of the specified areas, the image take-in section 16 takes in the respective image data of the respective XY coordinates E₁ (x₁, y₁) to E₃ (x₃, y₃) of the specified areas, from the inspection image data outputted from the image input section 8, in the size specified as the specified image data, in Step #12.

This time, the image take-in section 16 sequentially stores the respective specified image data corresponding to the respective XY coordinates E₁ (x₁, y₁) to E₃ (x₃, y₃) into the specified area memory 17 different from the defect image data memory 13, in Step #13.

The measurement inspection section 19 simultaneously performs the detailed inspections which are selectively designated to the respective specified image data, specifically at least one of the distribution measurement, the reinspection, and the Die-to-Die inspection on the respective specified image data corresponding to the respective XY coordinates E₁ (x₁, y₁) to E₃ (x₃, y₃) stored in the specified area memory 17, in Step #14.

For example, when the distribution measurement is designated to the specified image data corresponding to the XY coordinate E₁ (x₁, y₁) shown in FIG. 2, the measurement inspection section 19 performs the distribution measurement such as the pattern line width distribution or transmittance distribution on this specified image data, in Step #15. The measurement inspection section 19 displays on the monitor 20 a pattern line width distribution chart or transmittance distribution chart that is the result of the distribution measurement processing such as the pattern line width distribution or transmittance distribution on the specified image data, in Step #16.

When the reinspection is designated to the specified image data corresponding to the XY coordinate E₂ (x₂, y₂), the measurement inspection section 19 performs the reinspection on this specified image data in Step #17. In the reinspection, criteria different from the criteria of the defect inspection in the pattern defect inspection section 9 is adopted, specifically the threshold for judging a defect is set low, thereby enabling the defect detection of a feeble change in the brightness level. The measurement inspection section 19 displays the result of the reinspection as for the specified image data on the monitor 20 in Step #18.

When the Die-to-Die inspection is designated to the specified image data corresponding to the XY coordinate E₃ (x₃, y₃), the measurement inspection section 19 performs the Die-to-Die inspection on this specified image data in Step #19. In the Die-to-Die inspection, the same patterns formed on the specified image data are compared with each other, hence to recognize a disagreement as a pattern defected portion. The measurement inspection section 19 displays the result of the defect inspection through the Die-to-Die inspection as for the specified image data on the monitor 20, in Step #20.

According to the above embodiment, in parallel with the ordinary inspection of the photomask 2 detecting a defect by comparing the inspection image data obtained by imaging the photomask 2 with the reference data, specified image data corresponding to at least one specified area which requires a particular inspection on the photomask 2 is taken and stored into the specified area memory 17, and at least one processing of the distribution measurement processing of pattern line width and the like, the reinspection, and the Die-to-Die inspection of the same patterns is performed on the specified image data stored in the specified area memory 17. The defect image data detected by the ordinary inspection about the photomask 2 is stored into the defect image data memory 13, and the respective specified image data corresponding to the areas which require the detailed inspection such as pattern line width distribution and the like on the photomask 2, specifically, the respective XY coordinates E₁ (x₁, y₁) to E₃ (x₃, y₃) of the respective critical points E₁ to E₃ shown in FIG. 2, is sequentially stored into the specified area memory 17 different from the defect image data memory 13.

According to this, in parallel with the ordinary inspection of the photomask 2, at least one processing of the distribution measurement of pattern line width and the like, the reinspection, and the Die-to-Die inspection can be performed on the specified image data other than the defect image data, corresponding to the specified areas which require a particular inspection on the photomask 2, specifically, the respective XY coordinates E₁ (x₁, y₁) to E₃ (x₃, y₃) of the respective critical points E₁ to E₃.

Therefore, the critical points resulting from a simulation of exposing a semiconductor wafer through a photomask or an actual exposure can be fed back to the inspection and they are inspected again. When a designer selects processing from the distribution measurement, the reinspection, and the Die-to-Die inspection as for the respective critical points, the respectively-selected processing can be simultaneously performed on the above points.

The invention is not restricted to the above embodiment but it may be modified as follows.

In the above embodiment, although the distribution measurement of pattern line width and the like, the reinspection, or the Die-to-Die inspection of the same patterns is performed on the specified image data, it is not restricted to the above processing, but any other inspection may be performed.

Although the respective XY coordinates E₁ (x₁, y₁) to E₃ (x₃, y₃) of the respective critical points E₁ to E₃ are included in the inspection data as the position designation file (specified point), the respective areas of the XY coordinates E₁ (x₁, y₁) to E₃ (x₃, y₃) of the critical points E₁ to E₃ may be written into a predetermined file and this file may be included in the inspection data.

A transfer simulation may be executed by using the design data of the CAD apparatus and the critical points may be decided according to the result of this transfer simulation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image taking method comprising:
inspecting an object to be inspected, according to inspection image data obtained by imaging the object and reference data previously obtained; and
taking specified image data corresponding to at least one specified area on the object, in parallel with the inspection of the object.

2. The image taking method according to claim 1, wherein the specified area is previously designated as an area which requires a predetermined inspection level or a higher level as for the object.

3. An inspection method for an object to be inspected, comprising:
picking up an image of the object to obtain inspection image data;
inspecting the object according to the inspection image data and reference data previously obtained; and
taking in specified image data corresponding to at least one specified area on the object and storing it into a memory, in parallel with the inspection of the object.

4. The inspection method according to claim 3, wherein, during the inspection of the object, whether the position under the inspection is the specified area or not is checked, and when it is the position of the specified area, the specified image data corresponding to the specified area is taken in.

5. The inspection method according to claim 3, wherein the specified area is designated as an area which requires a predetermined inspection level or a higher level as for the object.

6. The inspection method according to claim 3, wherein the object has a photomask on which a pattern of a semiconductor integrated circuit is formed, and
the specified area is designated as an area which requires a detailed inspection of pattern line width distribution and the like on the photomask.

7. The inspection method according to claim 3, wherein the specified area has a point coordinate on the object or a two dimensional area which is previously set around the center of an XY coordinate on the object.

8. The inspection method according to claim 3, further comprising:
performing at least one processing out of distribution measurement for measuring at least distribution of pattern line width, reinspection for reinspecting the specified image data, and comparison inspection for inspecting a defect by comparing the pattern formed on the specific image data with the same pattern, on the specific image data stored in the memory.

9. An inspection apparatus of an object to be inspected, comprising:
an image pickup section which picks up an image of the object;
an inspection section which inspects the object according to inspection image data obtained by the image pickup section and reference data previously obtained;
a first memory; and
an image take-in section which takes in specified image data corresponding to at least one specified area on the object and stores the same data into the first memory, in parallel with the inspection processing of the object by the inspection section.

10. The inspection apparatus of an object to be inspected according to claim 9, further comprising a second memory,
wherein the inspection section compares the inspection image data with the reference data, recognizes a disagreement between the inspection image data and the reference data as defect data, takes in defect image data corresponding to the defect data, and stores the data into the second memory.

11. The inspection apparatus of an object to be inspected according to claim 9, wherein the object has a photomask on which a pattern of a semiconductor integrated circuit is formed.

12. The inspection apparatus of an object to be inspected according to claim 9, wherein the specified area is previously designated as an area which requires a predetermined inspection level or a higher level as for the object.

13. The inspection apparatus of an object to be inspected according to claim 11, wherein the specified area includes an area which requires a detailed inspection of pattern line width distribution and the like on the photomask.

14. The inspection apparatus of an object to be inspected according to claim 11, wherein the specified area includes a critical point on the photomask.

15. The inspection device of an object to be inspected according to claim 9, wherein the specified area includes a point coordinate on the object or a two dimensional area which is previously set around the center of an XY coordinate on the object.

16. The inspection apparatus of an object to be inspected according to claim 9, wherein, during the inspection of the object, the image take-in section checks whether the position under the inspection is the specified area or not, and takes in the specified image data corresponding to the specified area when it is the position of the specified area.

17. The inspection apparatus of an object to be inspected according to claim 9, further comprising:
a specified area designation section which previously designates at least the one specified area on the object.

18. The inspection apparatus according to claim 17, wherein, during the inspection of the object, the image take-in section checks whether or not the position under the inspection is the specified area designated by the specified area designation section, takes in the inspection image data corresponding to the specified area as the specified image data when it is the position of the specified area, and stores the data into the first memory.

19. The inspection apparatus of an object to be inspected according to claim 9, further comprising:
a measurement inspection section which performs at least one processing out of distribution measurement of at least pattern line width, reinspection for the specified image data, and comparison inspection for comparing the pattern formed on the specific image data with the same pattern, on the specified image data stored in the first memory.

20. The inspection apparatus of an object to be inspected according to claim 19, wherein the measurement inspection section performs at least one processing of the distribution measurement, the reinspection, and the comparison inspection, in parallel with the inspection of the object.
